(19) United States
(12) Patent Application Publication
(10) Pub. No.: US 2012/0096979 A1
(43) Pub. Date: Apr. 26, 2012

(54) VEHICLE STEERING DEVICE HAVING VEHICLE STEERING WHEEL

(75) Inventor: Sandra TRUJILLO LINKE, Frankfurt am Main (DE)

(73) Assignee: GM GLOBAL TECHNOLOGY OPERATIONS LLC, Detroit, MI (US)

(21) Appl. No.: 13/218,544

(22) Filed: Aug. 26, 2011

(30) Foreign Application Priority Data
Aug. 28, 2010 (DE) 102010035731.6

(51) Int. Cl. B62D 1/04

(52) U.S. Cl. 74/552

(57) ABSTRACT

A vehicle steering device is provided that has a rotatable vehicle steering wheel and at least one fixed display console in the field of vision of the driver. Control and display means are situated on the display console. A co-rotating right and the co-rotating left actuating console for selecting and operating the control and display means from the vehicle steering wheel are situated on the vehicle steering wheel.

### CROSS-REFERENCE TO RELATED APPLICATION

This application claims priority to German Patent Application No. 102010035731.6, filed Aug. 28, 2010, which is incorporated herein by reference in its entirety.

### TECHNICAL FIELD

The technical field relates to a vehicle steering device having a rotatable vehicle steering wheel and at least one fixed display console in the field of vision of the driver. Control and display means are situated on the display console.

### BACKGROUND

A vehicle steering wheel is known from publication EP 1 141 587 B1, which has input buttons on a crossbar of the vehicle steering wheel. A switching device for an electronically controlled automatic transmission of a motor vehicle is activated using the input buttons. In other steering wheel forms, input buttons are situated around an airbag area in the center of the steering wheel.

Such buttons on the crossbar of the steering wheel or around the airbag area require the driver to remove at least one hand from the vehicle steering wheel in order to actuate one of the input buttons. In addition, the driver must concentrate his vision on the steering wheel from the events of traffic for this purpose. It is not possible to perform inputs without visual contact on the steering wheel and without removing at least one hand from the steering wheel, in order to actuate the input buttons reliably and securely.

Therefore, at least one object is to provide a vehicle steering device having a rotatable steering wheel, whereby inputs of operationally-relevant functions can be executed from the steering wheel without visual contact with the steering wheel and without removing the hands from the steering wheel. In addition, other objects, desirable features and characteristics will become apparent from the subsequent summary and detailed description, and the appended claims, taken in conjunction with the accompanying drawings and this background.

### SUMMARY

In one embodiment, a vehicle steering device having a rotatable vehicle steering wheel and at least one fixed display console in the field of vision of the driver is proposed. Control and display means are situated on the display console. A co-rotating right actuating console and a co-rotating left actuating console are situated on the vehicle steering wheel for selecting and operating the control and display means from the vehicle steering wheel

This vehicle steering device has the advantage that the control means on the actuating consoles can be actuated by the driver without visual contact, i.e., blind, so that by means of the operating surfaces, an automobile radio, an automobile navigation device, an automobile telephone or mobile telephone, an Internet access device, a music storage device, or other communication devices are retrievable and controllable. A further advantage is that the best possible design for the vehicle steering wheel is provided with this vehicle steering device, so that the driver can easily control a plurality of functions from the vehicle steering wheel, so that it is not only possible to turn on the automobile radio, but rather also a broadcaster search, a volume regulation, a speech control, telecommunication connections, etc., can be controlled from the vehicle steering wheel.

For this purpose, no operating levers or switches are to be actuated on the vehicle steering column or on a central console of the vehicle, for which one hand would be removed from the vehicle steering wheel, but rather operating elements of the operating surfaces on the actuating consoles are to be touched or pressed, the actuating consoles being situated toward the driver on the steering wheel. A plurality of the control functions are operable by the thumbs of the hands of a driver from these operating elements in the operating surfaces of the actuating consoles. A greater degree of safety can be achieved by the usage of the vehicle steering device in cooperation with a display console and the actuating consoles directly on the steering wheel, since the driver is no longer extremely distracted from the surrounding street traffic in such a way by typical operating elements on the central console.

It is provided that when one of the operating elements of the operating surfaces is touched, the display console causes function symbols to be marked or illuminated, or acoustically signals which of them are activatable by at least one input button on one of the co-rotating actuating consoles. For activation, either the operating element itself or a separate input button can be actuated by pressure contact. In addition, it is further provided that inner edges of the actuating consoles have scroll functions, which execute control functions for preselected communication devices upon sliding touching, for example, volume, pitch, or balance controls. Instead of the scroll functions, preselection or favorite buttons can also be situated in each case below the co-rotating right and left input buttons, which activate a preselected favorite function in the menu after being pressed.

Fixed directional input buttons can also be situated as preset searches at fixed positions on the operating surfaces and can retrieve individual function symbols in different directions on the display console in the displayed menu. These fixed directional input buttons can have a raised edge and can trigger an audio identification signal or a light signal upon being touched, which signals to the driver that he has selected or touched the correct or the incorrect input button.

Instead of individual directional input buttons for each direction during the selection of the menu symbols, it is also possible in a further embodiment to situate an individual fixed input element on an operating surface in each case, which has a raised polygonal edge. Each edge side of the polygonal edge can trigger one direction of the search in a menu of the display console upon being touched or pressed, while the field within the polygon has the input button, which can be actuated after ending the preselection. In addition, it is also possible to provide a joystick on the operating surface as the single search and input element.

In further embodiments of the vehicle steering device, it is provided that at least two switch elements situated separately from one another are to be actuated simultaneously, in order to turn on gear change functions or other safety-relevant functions, which affect the vehicle operation or driving dynamics of the vehicle. This can be implemented in that, in addition to a switch element on the vehicle steering wheel, a foot pedal initiates such critical safety-relevant functions. On the other hand, both switch elements to be actuated simultaneously can also be provided on the steering wheel, which are situated at different locations from one another in such a way that both a left hand and also a right hand of a driver are required simultaneously in order to trigger or initiate a function such as a gear change or a vehicle operation change. This advantageously increases the reliability and the safety of the vehicle operation.

In a further embodiment, a left co-rotating switch element and a right co-rotating switch element are provided for this purpose on a lower side of a crossbar of the vehicle steering wheel, which are operable by the left or right hand, respectively, of the driver from the rotatable vehicle steering wheel, and activate gear change functions or other safety-relevant functions, which affect the vehicle operation or driving dynamics of the vehicle. For example, upshifting of the gears can be provided with a right-side switch element and downshifting of the gears can be provided with a left-side switch element. Plus or minus symbols or gear numbers can simultaneously display the shift status on the co-rotating operating consoles.

Instead of the arrangement of left and right co-rotating switch elements, which are not visible to the driver, on a lower side of a crossbar of the vehicle steering wheel, the actuating consoles can also serve as the switch elements, in that they are situated so they are pivotable on the vehicle steering wheel and preselect and activate gear change functions or other safety-relevant functions, which affect the vehicle operation or driving dynamics of the vehicle, by pivoting the actuating consoles. In order to prevent incorrect operation, simultaneous actuation of two switch elements either on the crossbar or the co-rotating and pivotable actuating consoles or a foot pedal and one of the switch elements is provided to activate a gear change function or other safety-relevant functions which affect the vehicle operation or driving dynamics of the vehicle, such as speed increase or cruise control functions.

In addition, gear preselect buttons can be situated in each case between the co-rotating right and left input buttons, in order to trigger a gear change from the steering wheel without visual contact. After pressing on a gear preset button, a gear preset can be retrieved and an automatic gear change can activated when the input buttons of both actuating consoles are pressed jointly. These actions can be triggered from the two ends on the actuating consoles in the form of horns or ears with the aid of the freely movable thumbs, without the driver permitting his field of vision to deviate from the flow of traffic.

Functions which have been heretofore activated blindly by foot pedals can be operated from the steering wheel using the hands, so that the foot well can be designed free of pedal levers. The frequently overloaded central console of a vehicle having its manifold of operating elements and display elements, which are only operable when the head of the driver turns downward and toward the central console, at least one hand being removed from the steering wheel in order to preselect, set, and activate the functions on the central console, can also therefore be dispensed with.

In addition to the possibility of performing the activation of gear changes or other functions relevant to vehicle operation solely through a specific input button arrangement on the actuating consoles blindly and without visual contact by the driver, it is also provided that function symbols are displayed, for example, on a display console which can be situated by a holding device on the non-rotatable steering column, which retrieve a function when the function symbol is touched, which is activatable by at least one input button on one of the co-rotating actuating consoles. This display console having function symbols is situated so it is well visible in proximity to the steering wheel, for example, so that the required visual contact by the driver does not impair his attentiveness to the flow of traffic.

A further embodiment additionally provides that the holding device on the steering column has a right-side display console and a left-side display console, the co-rotating right actuating console of the vehicle steering wheel being associated with the right-side display console and the co-rotating left actuating console of the vehicle steering wheel being associated with the left-side display console. On the one hand, this increases the number of the possible functions to be activated, on the other hand, it is possible to concentrate the functions which are relevant to vehicle operation and safety on one steering wheel side, and therefore on one display console, and to concentrate communicative function symbols so they are located on the other side of the steering wheel.

In a further embodiment, it is provided that the input buttons are situated as preselect finders or cursors so they are displaceable on the actuating consoles, in order to preselect individual function symbols on the display console by displacing the input button in at least two, or at most four movement directions and to activate the function by pressing at least one of the input buttons upon confirmation by illumination of the preselected function symbol on the display console.

In order to also separate safety-relevant function symbols from communicative function symbols with respect to location, it is provided in a second embodiment of the application that safety-relevant function symbols such as gear change function or other safety-relevant functions, which affect the vehicle operation or driving dynamics of the vehicle, such as speed increase or cruise control functions, are selectable on the left display console and are to be activated using at least the left input button or both input buttons, and communicative function symbols such as signal source selection are to be made activatable on the right display console using the right input button.

For this purpose, it is provided that, for example, a GPS street viewing program is displayed audio-visually on the display console upon selection of a GPS function symbol and activation by means of co-rotating right input button. In this way, the vision of the driver can remain concentrated on the events of traffic and nonetheless additionally use the right-side display console, which is situated in the surroundings of the steering wheel, for navigation.

In addition, it is provided that a list of radio frequency ranges or radio broadcasters is displayable on the right-side display console upon selection of a radio function symbol and activation by means of co-rotating right input button, and upon selection of a radio broadcaster on the display console, an audio menu of a selection of playback means such as headsets, earphones, or loudspeakers and a setting of the audio quality with respect to volume, bass or treble amplification or damping, or stereo balance are selectable by means of displacement of the right input button and by pressing the input button.

In addition, it is provided that a selection menu of various TV programs is listed on the right-side display console upon selection of a TV function symbol and activation using co-rotating right input button and a television program is activatable by selection by means of displacement of the input button and is displayable on the right-side display console. Therefore, the driver can also at least partially follow TV programs on the right-side display console, if desired, but can at least control corresponding display screens in the backrest of the front seats for vehicle occupants on the back seats from the vehicle steering wheel.

During the playback of the television program, further menus can be retrievable and selectable to set the image, sound, or format with respect to brightness, color rendering, contrast, volume, or magnification by means of displacement of the input button and are activatable by pressing the input button. However, an Internet access can also be placed on the right display console in TV programs alone, in order to produce communication with other vehicles and place an advance warning on the right display device in the event of traffic jams and other traffic obstructions, for example.

Furthermore, it is provided that a list of storage contents of a plug-in memory connected via USB is retrievable on the right-side display console upon selection of a USB function symbol and activation by means of co-rotating right input button and, upon selection of a storage content, it can be played audio-visually on the right display console.

In addition to the selection of a USB function symbol, it is also possible to select and activate a DVD signal source or a CDC memory card by means of co-rotating right input button on the right-side display console upon selection of a DVD function symbol or a CDC function symbol. Through the activation of the DVD signal source or a CDC memory card, an audio-visual playback of the DVD signal source or a storage space content of the CDC storage card can be incorporated on the display console by further function symbols in the display console.

A SETUP function symbol can thus be selected and activated by means of the co-rotating right input button, in order to incorporate alternative or additional function symbols with respect to e-mail or MMS or SMS communication or Internet accesses, for example, on the display console. The vehicle steering device thus becomes a central control element and allows the driver, with complete leg freedom, to preselect, search out, and activate all functions, which have heretofore been activated and monitored in the foot well and on the central console, directly from the steering wheel using the associated display consoles.

### BRIEF DESCRIPTION OF THE DRAWINGS

The present invention will hereinafter be described in conjunction with the following drawing figures, wherein like numerals denote like elements, and:

FIG. 1 is schematically shows a right section of a vehicle steering wheel of a vehicle steering device according to a first embodiment;

FIG. 2 is schematically shows a right section and a left section of a vehicle steering wheel of a vehicle steering device according to FIG. 1;

FIGS. 3A, 3B, and 3C schematically shows, a vehicle steering device having the right section of a vehicle steering wheel according to FIG. 1;

FIG. 4 is schematically shows, in FIGS. 4A to 4E, the left section of the vehicle steering wheel of the vehicle steering device according to FIG. 3 having scroll functional element;

FIG. 5 is schematically shows a vehicle steering wheel of a vehicle steering device having a joystick as an input element;

FIG. 6 is schematically shows a vehicle steering wheel of a vehicle steering device having a single polygonal input element;

FIG. 7 is schematically shows a bottom view of a vehicle steering wheel of a vehicle steering device according to a second embodiment;

FIG. 8 is schematically shows a top view of a vehicle steering wheel of a vehicle steering device according to FIG. 7;

FIG. 9 is schematically shows a top view of a modified vehicle steering wheel of a vehicle steering device according to FIG. 7;

FIG. 10 is schematically shows a perspective view of a vehicle steering wheel of a vehicle steering device according to a third embodiment;

FIG. 11 is schematically shows a perspective view of the vehicle steering wheel according to FIG. 10 having symbolized hand movement of a driver during activation of a gear change;

FIG. 12 is schematically shows a vehicle steering wheel of a vehicle steering device according to a fourth embodiment of the application; and

FIGS. 13A, 13B, 13C, and 13D schematically show in detail, a vehicle steering device having a vehicle steering wheel according to FIG. 12.

### DETAILED DESCRIPTION

The following detailed description is merely exemplary in nature and is not intended to limit application and uses. Furthermore, there is no intention to be bound by any theory presented in the preceding background or summary or the following detailed description.

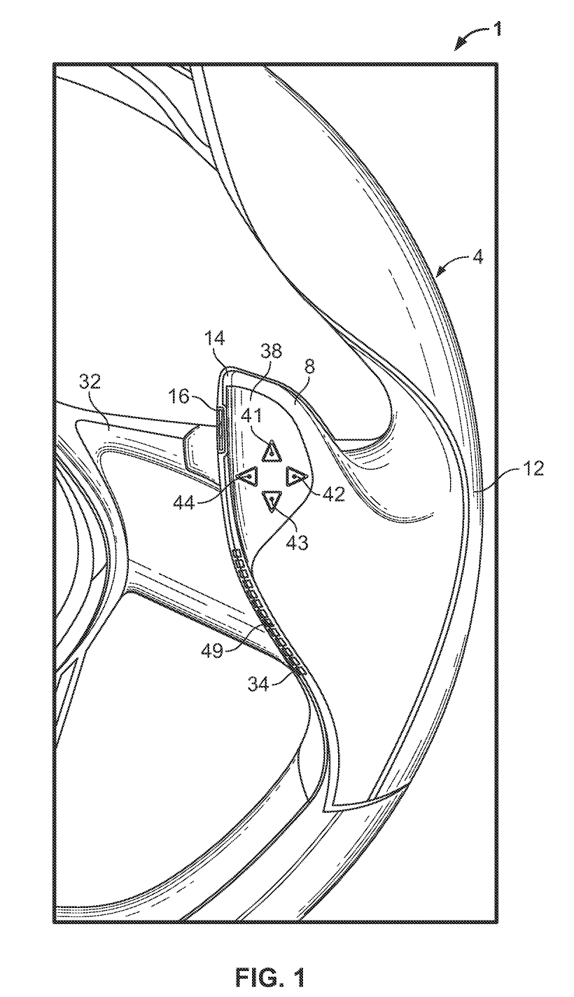

A right section of a vehicle steering wheel 4 of a vehicle steering device 1 is shown in FIG. 1. The vehicle steering wheel 4 has a rotatable outer ring 12, which is connected via a crossbar 32 to a co-rotating steering wheel linkage (not visible in this view) within a non-co-rotating steering column. A co-rotating right actuating console 8 having an operating surface 38 for selecting and operating various communication devices of the vehicle is situated on the outer ring 12. The actuating console 8 is in the form of a horn or an ear and is fixed on the right on the outer ring 12 of the vehicle steering wheel 4. The actuating console 8 protrudes into the inner area of the outer ring 12, a rounded, freestanding end 14 being oriented upward.

Directional input buttons 41, 42, 43, and 44 are situated on the operating surface. An input button 16 is situated on the inner edge 34 close to the freestanding end 14 of the actuating console 8, using which a function preselected by the directional input buttons 41, 42, 43, and 44 can be activated from a menu. A driver can actuate both the directional input buttons 41, 42, 43, and 44 of the operating surface 38 and also the input button 16 using his right hand, without removing his right hand from the vehicle steering wheel 4. In addition, the directional input buttons 41, 42, 43, and 44 are provided with raised edges, so that the driver does not have to look away from the street traffic in order to perform a preselection by the directional input buttons 41, 42, 43, and 44 in a menu of a display console. Such a display console (not shown in FIG. 1) is situated in the field of vision of the driver. To support the driver, touching the directional input buttons 41, 42, 43, and 44 can be made audible through various audio signals.

A scroll functional element 49 is situated in a lower area of the inner edge 34 of the right actuating console 8. Through sliding touching of the inner edge 34, the driver can actuate the scroll functional element 49 and set, for example, a broadcaster search selection, a volume, a pitch, or other audio properties of an automobile radio.

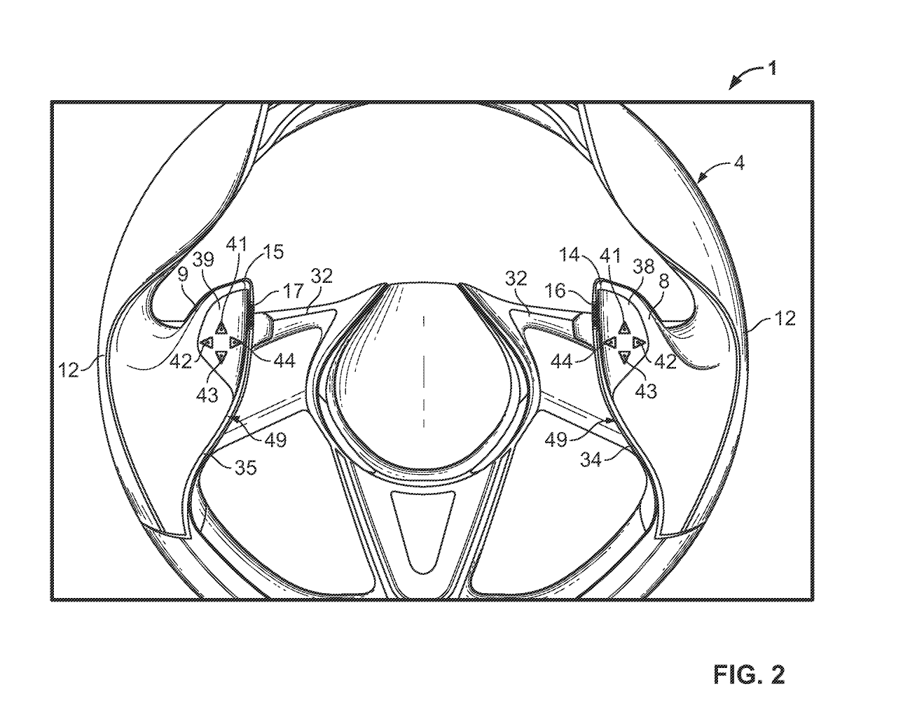

A top view of the right section and a left section of the vehicle steering wheel 4 according to FIG. 1 is shown in FIG. 2. Components having the same functions as in a preceding Fig. are identified by identical reference numerals in the following figs. and are not explained separately.

The left section is a mirror image of the right section. The additional left directional input buttons 41, 42, 43, and 44 are situated on a left operating surface 39 of a left actuating console 9. A left input button 17 and a further scroll functional element 49 are situated on the left inner edge 35 of the left actuating console 9. The second operating panel 39 can cooperate with the same display console as the first operating panel 38, or can be connected to a second display console (not shown in FIG. 2). The option is connected thereto that further function symbols can be retrieved in the second display console independently of the functions of a first display console.

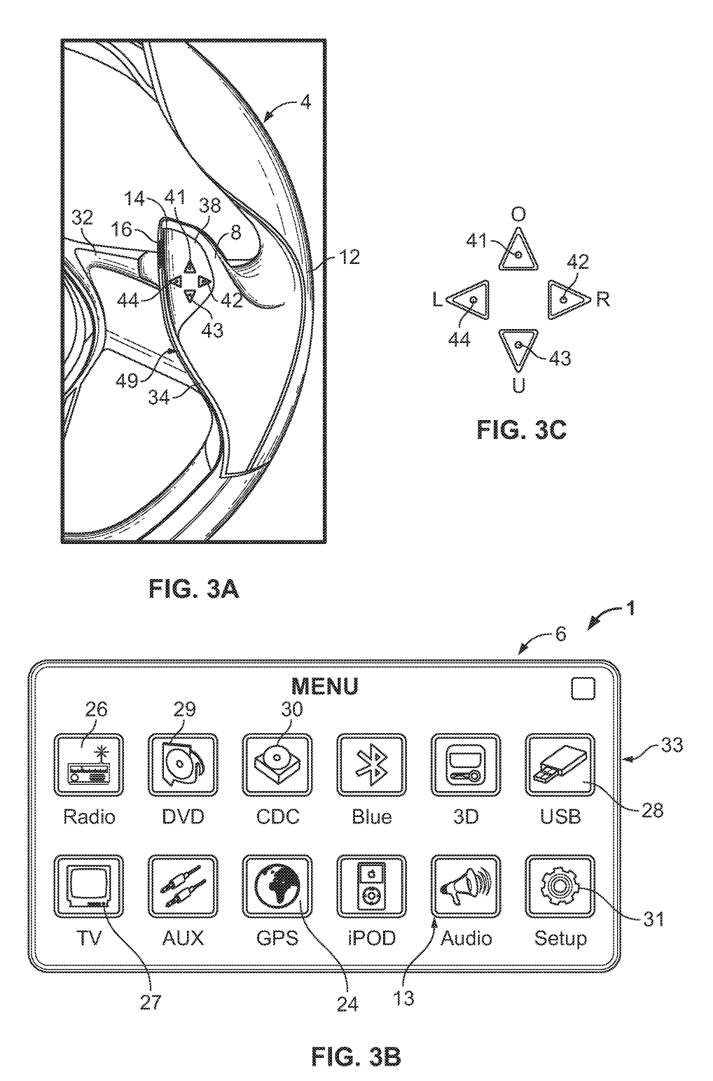

FIG. 3A, FIG. 3B, and FIG. 3C, shows a vehicle steering device having the right section of a vehicle steering wheel 4 according to FIG. 1 and a display console 6 in the field of vision of the driver. Such a display console 6 can be integrated in the central display area for monitoring the vehicle operation of the vehicle or can be provided as an independent display. Finally, it is also possible to integrate such a display console 6 in a windshield or to project it on the windshield.

The display console 6 can be operated from the co-rotating right actuating console 8. Via the directional input buttons 41, 42, 43, and 44, which co-rotate with the vehicle steering wheel 4, as shown in FIG. 3C, function symbols can be selected upward in arrow direction O, downward in arrow direction U, to the right in arrow direction R, and to the left in arrow direction L in the display console 6, which is shown in FIG. 3B. The respective function can be activated by pressing the input button 16. Thus, for example, FIG. 3B shows a main menu 33 having twelve different function symbols 13, which are preselectable with the aid of the directional input buttons 41, 42, 43, and 44, for example, and are activatable by pressing the input button 16. For example, a list of possible radio broadcasters can be retrieved by selecting the radio function symbol 26, for example.

Correspondingly, by selecting a TV function symbol 27, a list of television broadcasters can appear on the display console 6. Upon the selection of a GPS function symbol 24, for example, an image of a GPS street viewing program can be displayed on the display console 6. Upon the selection of a USB function symbol 28 or a DVD function symbol 29 or a CDC function symbol 30, for example, a USB or DVD or CDC signal source can be preselected and activated using the input button 16. Upon selection of a SETUP function symbol 31, for example, further function symbols can be incorporated into the main menu 33 shown in FIG. 3B, such as an Internet access or other function symbols for signal sources. Alternatively, the selection can also be provided by touching the function symbols on the display console 6, however, this requires that the driver removes at least one hand from the vehicle steering wheel 4 and dispenses with the operating comfort which the actuating console 8 offers. In the case of a parking vehicle, such a so-called “touchscreen display console” can be advantageous.

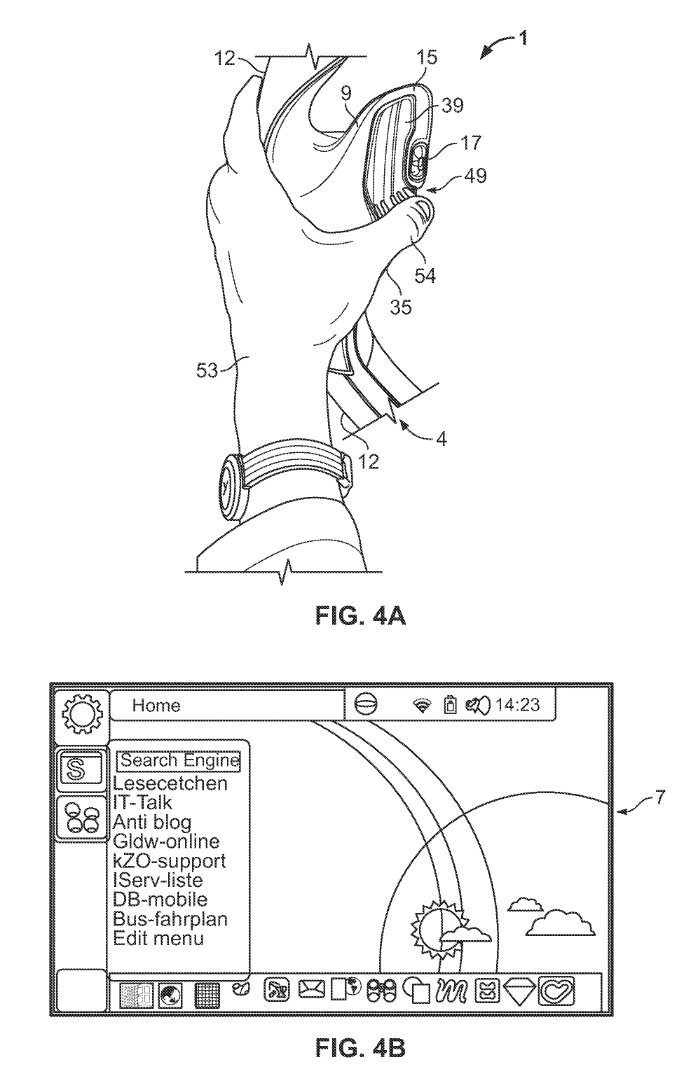

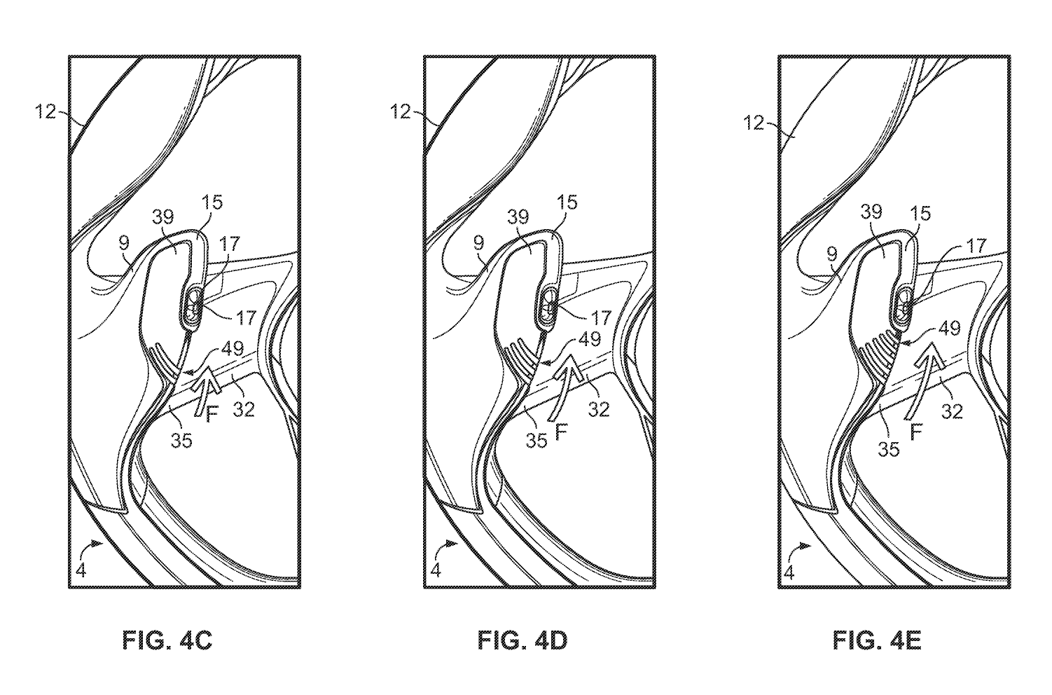

FIG. 4A to FIG. 4E, show the left section of the vehicle steering wheel 4 of the vehicle steering device 1 according to FIG. 3 with operation of the scroll functional element 49 on the left inner edge 35 of the actuating console 9 by a left hand 53 of a driver. By sliding up or down with a thumb 54 of his left hand 53 in or opposite to the arrow direction F, as shown in FIG. 4C to FIG. 4E, it is possible for the driver to select various services from the Internet from the menu of a left display console 7, which is shown in FIG. 4B. The selected service can be retrieved or requested by pressing the left input button 17.

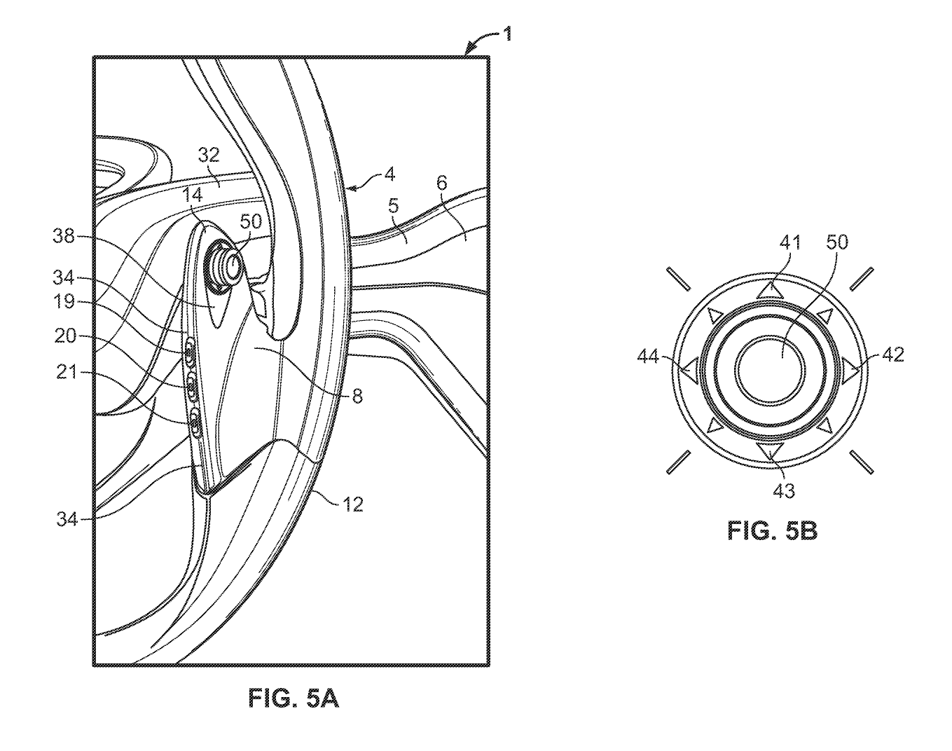

A right section of the vehicle steering wheel 4 having a modified joystick 50 on the operative surface 38 of the vehicle steering device is shown in FIG. 5. The joystick 50 can, as shown in FIG. 5D, travel as an input element through the menu field of the display console 6 like a cursor in nearly arbitrary direction and select an arbitrary function, which is activatable by pressing the joystick 50. Instead of a scroll functional element, preselect buttons 19, 20, and 21 are provided in this vehicle steering wheel 4 on the inner edge 34 of the right actuating console 8, on which favorite functions from the menu of the display console 6 can be placed, so that more rapid access is possible. The display console 6, of which only a section is shown, is situated in this case via a holding device 5 on a non-co-rotating steering column.

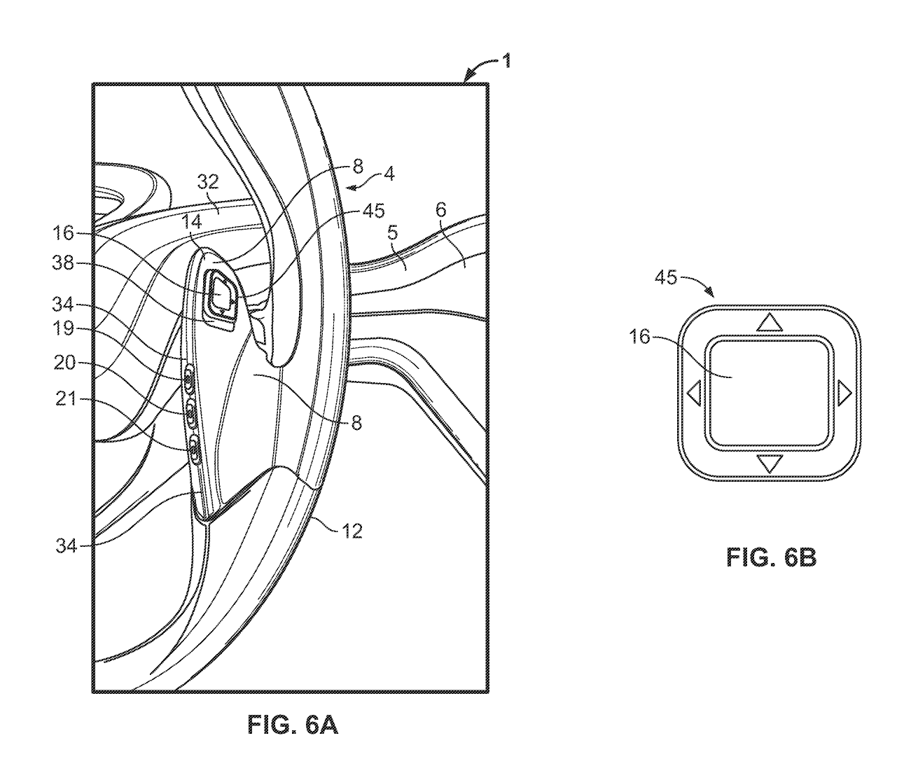

The right section of the vehicle steering wheel 4, as shown in FIG. 5, is also shown in FIG. 6. However, a single polygonal input element 45 is situated on the operating surface 38 of the right actuating console 8 in place of the joystick. The input element 45 has raised edges. The edges form directional input buttons. By touching or pressing one edge of the polygonal input element 45, a preselection of a function symbol on the display console is performed and the function is activated by pressing the polygonally bounded inner surface of the input element 45. The inner surface of the input element 45 therefore forms the input button 16. Therefore, no input button is required on the inner edge 34, and therefore preselect buttons 19, 20, and 21 can be preprogrammed for favorite functions.

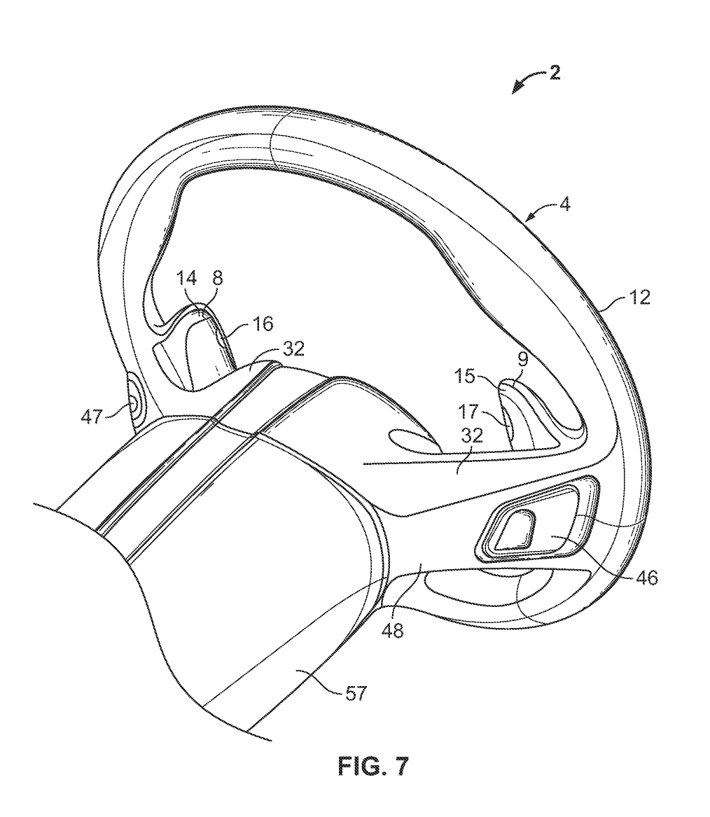

FIG. 7 shows a second embodiment of a vehicle steering device 2 of the application in a bottom view of the vehicle steering wheel 4. The vehicle steering wheel 4, which is visible from its lower side 48 and is rotatable in relation to a steering column 57, is situated on the non-co-rotating steering column 57. In this embodiment, a gear change of a shift transmission or a vehicle operation change of a vehicle having automatic transmission from the vehicle steering wheel 4 is provided. For this purpose, switch elements 46 and 47 are provided, which are actuable from the outer ring 12 of the vehicle steering wheel 4, and are situated on the lower side 48 of the crossbar 32. To switch over gear change functions or other safety-relevant functions, which affect the vehicle operation or driving dynamics of the vehicle, it is provided that at least two switch elements separated from one another with respect to location are actuated. This can be performed by actuating the switch elements 46 and 47, which are in the area of the left hand and the right hand of a driver. On the other hand, a foot pedal can be provided, which is to be actuated in addition to a switch element 46 or 47 of the vehicle steering wheel 4.

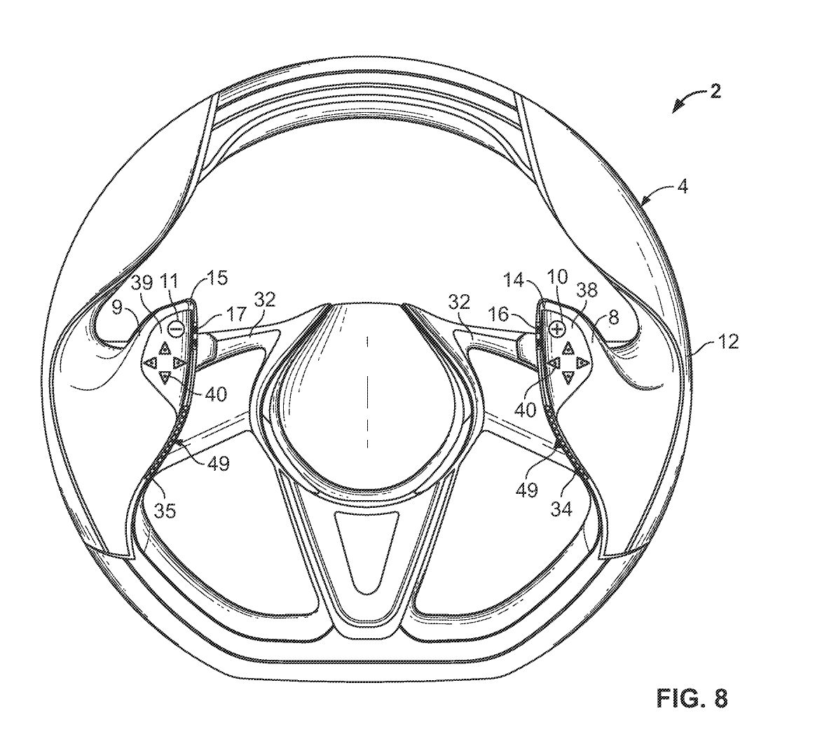

On the front side of the vehicle steering wheel 4, as shown in FIG. 8, the possibility of gear upshifting by a right switch element 46 situated on the lower side of the crossbar 32 can be marked, in addition to the operating elements 40, by a plus symbol on the right operating surface 38 and by a right gear display 10. The possibility of gear downshifting can be displayed, in addition to the operating elements 40, by a minus symbol on the left operating surface 39 and by a gear display 11.

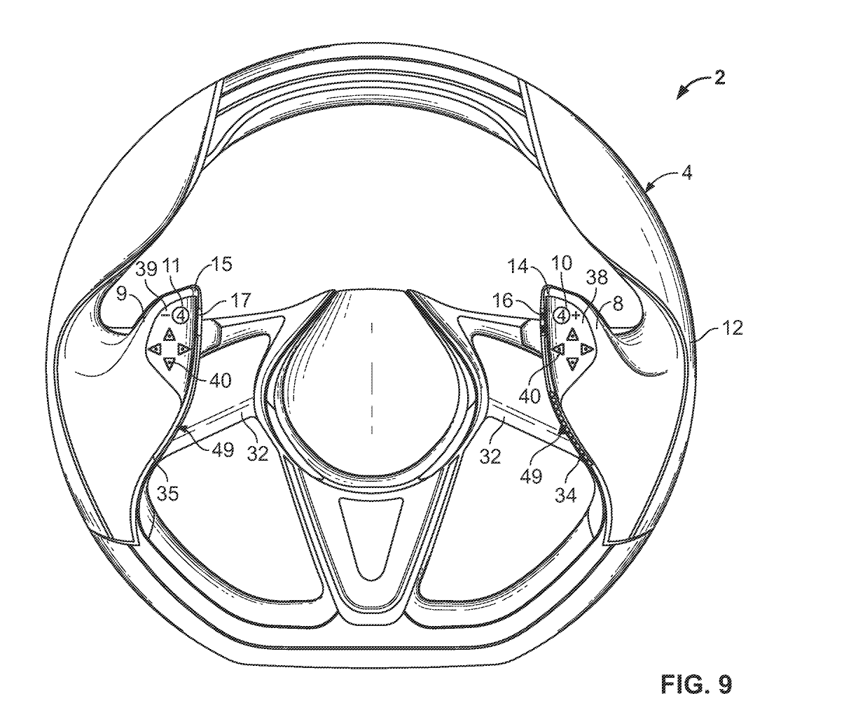

The possibility of confirming the respective activated gear using the gear displays 10 and 11 on the operating surfaces 38 and 39 is shown in FIG. 9. An additional plus or minus symbol can inform the driver which switch element is to be actuated in order to change from the displayed gear to a higher gear or a lower gear with the aid of the switch elements.

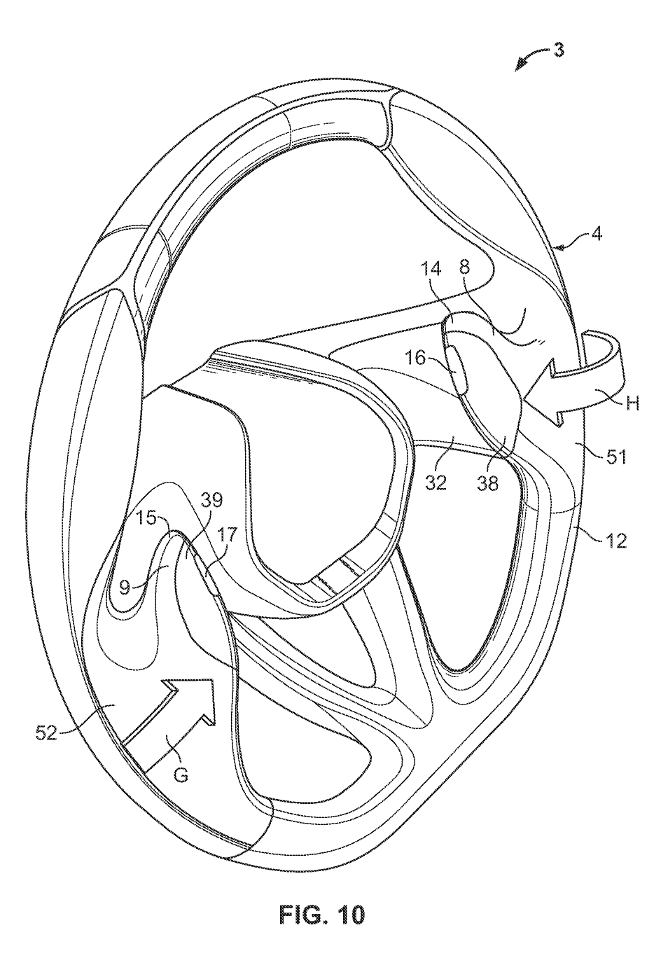

FIG. 10 shows a vehicle steering wheel 4 of a vehicle steering device 3 according to a third embodiment having actuating consoles 8 and 9 which are pivotable or tiltable around the outer ring 12. The actuating consoles 8 and 9 are additionally used as switch elements 51 and 52 in this embodiment. A pivot movement by a few millimeters in the arrow directions G or H can be used in order to preselect and/or activate gear change functions or other safety-relevant functions which affect the vehicle operation or driving dynamics of the vehicle. The preselection can be performed by actuating one of the two actuating consoles 8 or 9 and the activation can only be triggered by simultaneously actuating both actuating consoles 8 and 9, for the sake of safety. An assignment of the right or left actuating console to upshifting or downshifting can be provided as in the second embodiment. A display of a currently operated gear or vehicle operation in the operating surfaces 38 and 39 can also be performed as in the second embodiment. As FIG. 11 shows, both thumbs 54 and 56 of the left hand 53 or the right hand 55 can be used to pivot or tilt the actuating consoles 8 and 9 in the arrow directions F and H.

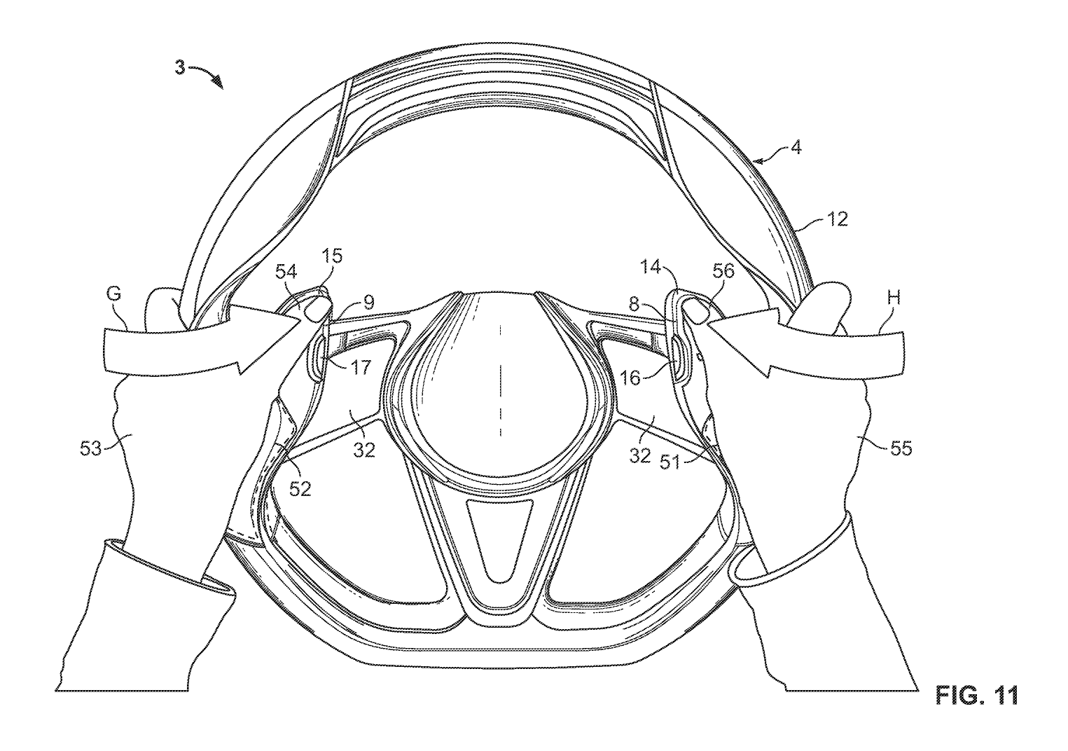

FIG. 12 shows a vehicle steering wheel 4 of a vehicle steering device 60 according to a fourth embodiment of the application. Three preselection buttons 19, 20, and 21, for example, for preselecting the second, third, and fourth gears of the vehicle, are situated below the input button 16 on an inner edge 34 of the right actuating console 8. Preselection buttons 18 and 22 are provided on an inner flank 35 of the left actuating console 9 under the input button 17, for example, the first forward gear being preselectable using the button 18 and the reverse gear being preselectable using the button 22. In order to activate the individual gears, it is provided that the driver encloses the actuating consoles 8 and 9 using both hands and actuates both input buttons 16 and 17 together and, simultaneously using both thumbs, activates the preselected gear after preselection of a gear with the aid of one of the preselection buttons 18 to 22. This serves for safety, so that in the event of unintentional actuation of one of the input buttons 16 or 17, a gear change cannot be triggered.

The provision of the first forward gear and the reverse gear on the left side having the gear preselection buttons 18 and 22 has the advantage that during driving maneuvers having multiple changes from the first gear into the reverse gear, it is preselectable using the same hand and therefore a more rapid change from forward travel to reverse travel is possible during parking of the vehicle, for example. Simultaneously, the right preselection buttons 19 to 21 can be electronically locked such that a change into the reverse gear 22 is not activatable from the right buttons.

This vehicle steering device has the advantage that the driver can initiate a gear change from the vehicle steering wheel 4, without having to look at the vehicle steering wheel 4 itself. In addition, this steering wheel device has the advantage that a shift lever on the central console can be dispensed with, and finally, only an acceleration lever in the form of the gas pedal and a brake lever in the form of the brake pedal remain in the foot well. These functions can also be integrated in such a steering device, as shown in the following figures, so that the foot well of the driver is fully free of pedals.

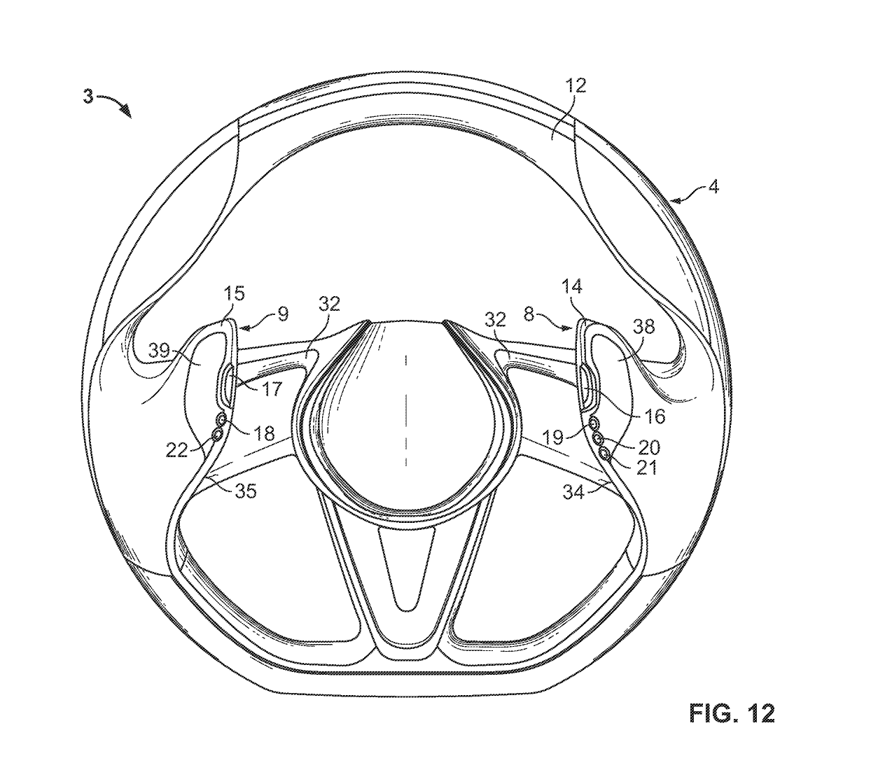

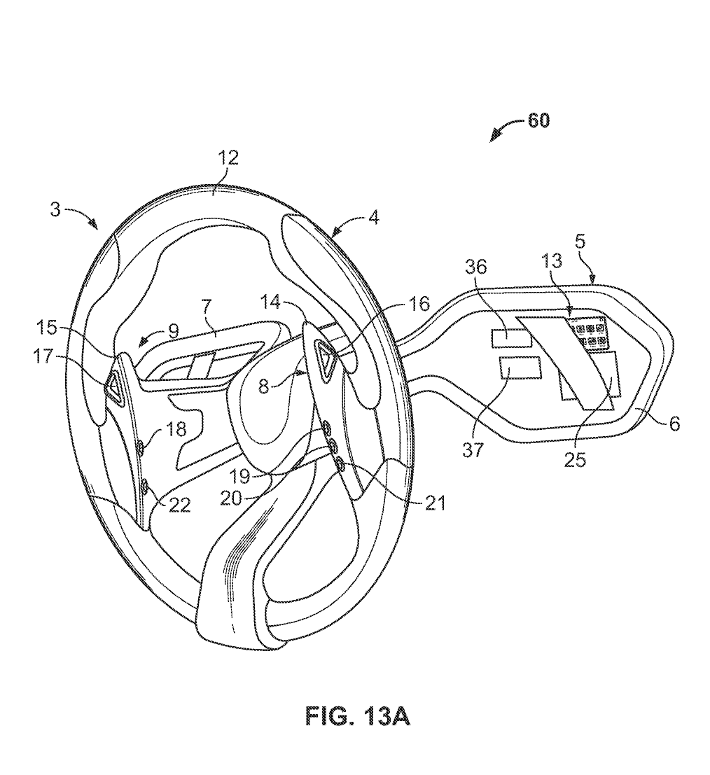

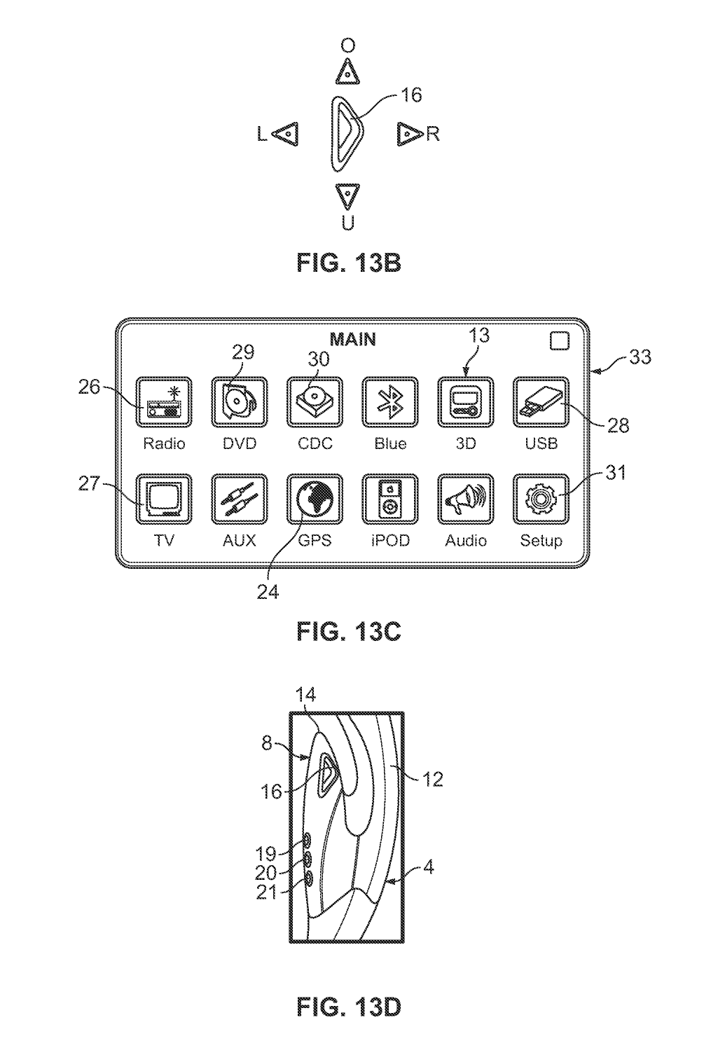

FIG. 13 shows a vehicle steering device 60 according to FIG. 12 in detail in FIGS. 13A, 13B, 13C, and 13D. In this fourth embodiment of the application, a holding device 5, which has a right-side display console 6 and a left-side display console 7, is situated on a non-co-rotating steering column, which encloses a co-rotating steering wheel rod of the vehicle steering wheel 4. The right-side display console 6 can be operated from the co-rotating right actuating console 8, while the left-side display console 7 is operable from the co-rotating left actuating console 9.

With this embodiment, in addition to a gear preselection with the aid of the gear preselection buttons 19 to 22, as were already described in FIG. 12, an input button 16 or 17 can now be provided on each of the actuating consoles 8 and 9 protruding into the inner area of the outer ring 12 of the vehicle steering wheel 4. As shown in FIG. 13B, such an input button 16 can be displaced upward in the arrow direction 0, downward in the arrow direction U, to the right in the arrow direction R, and to the left in the arrow direction L. Various function symbols 13 can be preselected on the associated right display console 6 with this displacement and the respective function can be activated by pressing the input button 16.

Thus, for example, FIG. 13C shows a main menu 33 having 12 different function symbols 13, which are preselectable with the aid of the right input button 16 and are activatable by pressing the input button 16, for example. By the selection of the radio function symbol 26, for example, as shown by the display console 6, a list 36 of preferred radio broadcasters can be listed.

A list of television broadcasters 37 can accordingly appear on the display console 6 by selecting a TV function symbol 27. Upon the selection of the GPS function symbol 24, for example, an image of a GPS street viewing program 25 can be displayed on the display console 6. Upon the selection of a USB function symbol 28 or a DVD function symbol 29 or a CDC function symbol 30, for example, a USB or DVD or CDC signal source can be preselected and activated using the input button 16. Upon selection of a SETUP function symbol 31, for example, further function symbols can be incorporated into the main menu 33 shown in FIG. 13C, for example, an Internet access or other function symbols for signal sources. Alternatively, the selection can also be provided by touching the function symbols; however, this requires that the driver removes at least one hand from the vehicle steering wheel 4.

FIG. 13D shows a detail view of the right operating console 8 on the vehicle steering wheel 4 having the outer ring 12, the right actuating console 8 protruding into the inner ring 12 and having a horn-shaped form having an upwardly directed, rounded, freestanding end 14, an input button 16 displaceable in four directions being situated and further preselection buttons 19 to 21 for the preselection of forward gears being provided on the right actuating console 8, as already explained in FIG. 12.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle steering device, comprising:
a rotatable vehicle steering wheel having a fixed display console in a field of vision,
a controller situated on the fixed display console,
a display situated on the fixed display console;
a co-rotating right actuating console situated on the rotatable vehicle steering wheel; and
a co-rotating left actuating console situated on the rotatable vehicle steering wheel,
wherein the co-rotating right actuating console and the co-rotating left actuating console are configured for selecting and operating the controller and the display from the rotatable vehicle steering wheel.

2. The vehicle steering device according to claim 1, wherein the co-rotating right actuating console and the co-rotating left actuating console are fixed on an outer ring to a right and a left of the rotatable vehicle steering wheel and protrude into an inner area of the outer ring, the co-rotating right actuating console and the co-rotating left actuating console having operating surfaces with operating elements that are reachable from the rotatable vehicle steering wheel.

3. The vehicle steering device according to claim 2, wherein a communication device is retrievable and controllable with the operating surfaces.

4. The vehicle steering device according to claim 2, wherein a music device is retrievable and controllable with the operating surfaces.

5. The vehicle steering device according to claim 2, wherein, when one of the operating elements is touched, the fixed display console is configured to show function symbols, which are activatable by an input button on the co-rotating right actuating console or the co-rotating left actuating console.

6. The vehicle steering device according to claim 2, wherein, when one of the operating elements is touched, the fixed display console is configured to show function symbols, which are activatable by an input button on the co-rotating left actuating console.

7. The vehicle steering device according to claim 1, wherein inner edges of the co-rotating right actuating console and the co-rotating left actuating console have scroll functions that are configured to provide control functions for preselected communication devices upon sliding touching.

8. The vehicle steering device according to claim 2, wherein fixed directional input buttons are situated as preselection searches at fixed positions on the operating surfaces that are configured to retrieve individual function symbols in different directions on the fixed display console.

9. The vehicle steering device according to claim 8, wherein fixed operating elements have a raised edge and trigger an audio identification signal.

10. The vehicle steering device according to claim 9, wherein a single input element is situated on each operating surface and has a raised polygonal edge, and each edge side of the raised polygonal edge provides one direction of a search in a menu of the fixed display console.

11. The vehicle steering device according to claim 10, wherein the single input element is a joystick.

12. The vehicle steering device according to claim 1, wherein at least two switch elements situated separately from one another are to be actuated simultaneously in order to turn on gear change functions or other safety-relevant functions which affect a vehicle operation or driving dynamics of a vehicle.

13. The vehicle steering device according to claim 10, wherein a left co-rotating switch element and a right co-rotating switch element are situated on a lower side of a crossbar of the rotatable vehicle steering wheel, which are operable by a driver from the rotatable vehicle steering wheel and activate safety-relevant functions that affect vehicle operation.

14. The vehicle steering device according to claim 13, wherein upshifting of gears is provided with a right-side switch element and downshifting of gears is provided with a left-side switch element, and a polarity symbol display a shift state.

15. The vehicle steering device according to claim 1, wherein the co-rotating right actuating console and the co-rotating left actuating console serve as switch elements and are pivotably situated on the rotatable vehicle steering wheel and gear change functions, which affect vehicle operation, are activatable by pivoting the co-rotating right actuating console and the co-rotating right actuating console.

16. The vehicle steering device according to claim 10, wherein preselection buttons, which activate a favorite function preselected in the menu after pressing one of the preselection buttons, are situated in each case below the co-rotating right actuating console and the co-rotating left actuating console.
